(19) United States
(12) Patent Application Publication
(10) Pub. No.: US 2025/0188229 A1
(43) Pub. Date: Jun. 12, 2025

(54) MATERIALS PREPARED BY COVALENT SELF-ASSEMBLY OF POLYMERS

(71) Applicant: RHEINISCH-WESTFÄLISCHE TECHNISCHE HOCHSCHULE (RWTH) AACHEN, Aachen (DE)

(72) Inventors: Yang Shi, Aachen (DE); Xiangyang Bai, Aachen (DE); Twan Lammers, MAASEIK (BE)

(21) Appl. No.: 18/856,354

(22) PCT Filed: Apr. 4, 2023
(86) PCT No.: PCT/EP2023/058775

§ 371 Date: Oct. 11, 2024

(30) Foreign Application Priority Data
Apr. 12, 2022 (DE) 10 2022 108 815.4

(51) Int. Cl. C08J 3/24; C08F 2/38; C08F 120/56; C08J 3/075; C08K 5/25

(52) U.S. Cl. CPC C08J 3/24; C08F 2/38; C08F 120/56; C08J 3/075; C08K 5/25; C08F 2438/03; C08J 2333/26

(57) ABSTRACT

The present invention concerns a method of producing at least one morphology-defined polymer aggregate by directly and covalently crosslinking polymer entities, the method comprising (a) providing polymer entities bearing covalently crosslinkable groups and respective crosslinker entities, the polymers bearing functional groups cross-linkable by the crosslinkers; and (b) bringing the polymer entities and the crosslinker entities in contact with each other in a solution under conditions that allow the polymer entities to aggregate or assemble into an ordered structure and be intermolecularly crosslinked in one step.

### TECHNICAL FIELD

The invention pertains to the field of producing polymer aggregates. More specifically, the present invention relates to a method of producing at least one polymer aggregate by allowing polymers to covalently self-assemble into the polymer aggregate(s). The polymer aggregates range from nano-scale to macro-scale structures, and find applications in biomedical engineering including drug delivery and tissue engineering, as well as other materials engineering fields including catalysis, energy and environment.

### BACKGROUND OF THE INVENTION

Self-assembly plays a crucial role in nature and materials science. In nature, biomolecules self-assemble into organelles, which further organize into cells and multicellular living organisms. Similarly, self-assembly is used in materials synthesis to organize small, independent units into increasingly complex structures and materials. To give an example, polymers are used to make structures such as nanoparticles, fibers, and hydrogels. These materials, even though they are crucial in many fields (particularly in biomedical applications), have fundamental limitations: current methods only report polymer self-assembly by weak non-covalent interactions, like hydrophobic, electrostatic, or π-π stacking interactions and hydrogen bonding, which are all highly sensitive to environmental conditions such as solvent polarity, temperature, ionic strength, pH, and co-solutes. Furthermore, even if these conditions are carefully optimized to stabilize the polymer assembly, controlling the architecture of the resulting material is exceedingly difficult, further complicating the synthesis or even making it impossible to produce the target structure without destroying the polymer constituents.

Due to these limitations, the inventors of the present application sought to provide a method that is capable to produce polymer materials having increased stability. In addition, fabrication of complex structures that can be modulated in shape and/or size over several scales should be possible.

This problem is solved by a method of producing at least one polymer aggregate. The polymer aggregate is constituted from intermolecularly crosslinked polymer entities. It has an ordered structure and may therefore be described as a morphology-defined polymer aggregate. The method comprises the following steps:
(a) providing polymer entities bearing covalently crosslinkable groups and respective crosslinker entities;
(b) bringing the polymer entities and the crosslinker entities in contact with each other in a solution under conditions that allow the polymer entities to aggregate or assemble into an ordered structure and be intermolecularly crosslinked in one step; and,
(c) optionally, recovering at least one polymer aggregate.

The present invention relates to a novel polymer self-assembly strategy based on covalent interactions. This is not only fundamentally different from conventional non-covalent self-assembly, it also enables new fabrication strategies for nano-scale to macro-scale structures, in particular hydrogels and porous scaffolds. This method has broad applications in materials syntheses for biomedical engineering including drug delivery and tissue engineering as well as other materials engineering fields including catalysis, energy and environment.

The production of the polymer aggregate according to the present invention proceeds essentially via a one-step process. In the present context, the expression “one-step process” implies that the self-assembly and the crosslinking generally occurs substantially simultaneously and/or under substantially identical conditions. The term “entities” in the context of the polymer and the crosslinker denotes plural individual polymer molecules and plural individual crosslinker molecules, respectively.

The present invention overcomes the drawbacks of non-covalent polymer self-assembly and is able to effectively produce nano-scale to macro-scale hydrogels with simple protocols and tight control of physico-chemical properties. The method can be flexibly modulated by simple controlling strategies enabling the fabrication of materials, which are challenging to produce with previously existing methods.

A further aspect of the present invention relates to polymer aggregate(s) produced or producible according to the method of the invention, as well as corresponding 3-dimensional porous scaffolds.

The present disclosure in particular provides the following embodiments:

Embodiment 1. Method of producing at least one morphology-defined polymer aggregate by directly and covalently crosslinking polymer entities, the method comprising:
(a) providing polymer entities bearing covalently crosslinkable groups and respective crosslinker entities;
(b) bringing the polymer entities and the crosslinker entities in contact with each other in a solution under conditions that allow the polymer entities to aggregate or assemble into an ordered structure and be intermolecularly crosslinked in one step; and,
(c) optionally, recovering at least one polymer aggregate.

Embodiment 2. Method of embodiment 1, wherein the crosslinkable groups are selected from the group consisting of ketones, aldehydes, carboxylic acids and their derivatives, hydroxyls, amines, hydrazines, hydrazides, hydroxylamines, disulfides, maleimides, azides, alkynes, strained alkenes, tetrazines and tetrazoles.

Embodiment 3. Method of embodiment 1 or 2, wherein the crosslinkable groups are in the repeating unit of the polymer entities.

Embodiment 4. Method of any of the preceding embodiments, wherein at least 50%, at least 60%, at least 70%, at least 80%, at least 90%, at least 91%, at least 92%, at least 93%, at least 94%, at least 95%, at least 96%, at least 97%, at least 98%, at least 99%, or all of the repeating units are crosslinkable.

Embodiment 5. Method of any of the preceding embodiments, wherein the polymer entities have a number averaged molecular weight (Mn) ranging from 1,000 to 500,000, preferably 2,000 to 100,000, more preferably 3,000 to 50,000, more preferably 4,000 to 20,000, most preferably 5,000 to 15,000.

Embodiment 6. Method of any of the preceding embodiments, wherein the polymer entities comprise or consist of poly(acrylates), poly(methacrylates), poly(acrylamides), poly(methacrylamides), poly(vinylethers) and derivatives thereof, preferably ketone-bearing poly(methacrylamides) and poly(acrylamides), in particular poly(N-(2-oxopropyl) methacrylamide) (pOPMA).

Embodiment 7. Method of any of the preceding embodiments, wherein the crosslinker entities have two or more crosslinking groups, wherein, optionally, the two or more crosslinking groups are spaced apart from each other by respective linkage(s) of 1 to 1000 atoms, preferably 2 to 10 atoms, in length.

Embodiment 8. Method of any of the preceding embodiments, wherein the crosslinks are degradable or cleavable.

Embodiment 9. Method of any of the preceding embodiments, wherein the crosslinker entities are selected from the group consisting of ketones, aldehydes, carboxylic acids and their derivatives, hydroxyls, amines, hydrazines, hydrazides, hydroxylamines, disulfides, maleimides, azides, alkynes, strained alkenes, tetrazines and tetrazoles.

Embodiment 10. Method of any of the preceding embodiments, wherein 5 to 100% of the repeating units of the polymer aggregate(s) are crosslinked.

Embodiment 11. Method of any of the preceding embodiments, wherein the solution comprises or consists of water, buffers, acetone, ethyl acetate, hexane, heptane, dichloromethane, methanol, ethanol, tetrahydrofuran, acetonitrile, dimethylformamide, N,N-dimethylacetamide, toluene, dimethylsulfoxide and mixtures thereof.

Embodiment 12. Method of any of the preceding embodiments, wherein the produced polymer aggregate(s) is/are selected from the group consisting of nanoparticles, microstructures and macrostructures, preferably wherein the microstructures and macrostructures are composed of nanoparticles.

Embodiment 13. Method of embodiment 12, wherein the nanoparticles range in size from 5 nm to 999 nm, preferably from 8 to 150 nm.

Embodiment 14. Method of any of the preceding embodiments, wherein the size of the produced polymer aggregate(s) is modulated via polymer concentration, crosslinking concentration, polymer molecular weight and crosslinking reaction speed.

Embodiment 15. Method of embodiment 14, wherein the crosslinking reaction speed is controlled via catalyst concentration and/or temperature.

Embodiment 16. Method of any of the preceding embodiments, wherein, when the solution contains water, in step (b) the pH value ranges from 3.0 to 9.5, preferably from 5.0 to 8.5.

Embodiment 17. Method of any of the preceding embodiments, wherein a plurality of nanoparticles is produced with a polydispersity index (PDI) of below 0.7, preferably below 0.5, more preferably below 0.3.

Embodiment 18. Method of any of the preceding embodiments, wherein the polymer entities and the crosslinker entities are brought in contact with each other by injecting solutions of the polymer entities and the crosslinker entities into a microfluidic device through separate inlets.

Embodiment 19. Method of embodiment 18, wherein the contacted solutions are cut by a phase substantially immiscible with the contacted solutions such that the polymer entities and the crosslinker entities self-assemble to a covalently connected chain of nanoparticles that can be recovered at an outlet of the microfluidic device.

Embodiment 20. Method of any of the preceding embodiments, wherein the surface and/or interior of the polymer aggregate(s) is/are functionalized, preferably wherein the functionalization confers cell adherence properties to the polymer aggregate(s).

Embodiment 21. Method of any of the preceding embodiments, wherein the polymer aggregate(s) is/are loaded with a bioactive agent, optionally wherein the bioactive agent is covalently or physically retained in and/or on the surface of the polymer aggregate(s).

Embodiment 22. Method of any of the preceding embodiments, wherein a plurality of chains of nanoparticles and/or microstructures are formed and printed into a 3-dimensional porous scaffold.

Embodiment 23. Method of any of the preceding embodiments, wherein the polymer entities and the crosslinker entities are brought in contact with each other by injecting solutions of the polymer entities and the crosslinker entities into a space or reservoir to form polymer aggregate(s) locally.

Embodiment 24. Polymer aggregate(s), produced according to the method of any of embodiments 1 to 23.

Embodiment 25. 3-Dimensional porous scaffold, produced according to the method of embodiment 22.

Further aspects, embodiments and advantages of the invention will be apparent from the detailed description and the experimental section together with the drawings and the claims.

### BRIEF DESCRIPTION OF THE DRAWINGS

FIG. 1A) Reaction scheme of covalent crosslinking of POPMA with adipic acid dihydrazide (ADH), which is catalyzed by H⁺ or aniline. B) Schematic depiction of covalent self-assembly of POPMA forming nanogels at low degrees of crosslinking (above), and at high degrees of crosslinking (below), the nanogels further self-assemble into macro-scale hydrogels.

FIG. 2 Nano- and micro-scale hydrogel formation from pOPMA via the COSA. A) Photographs of a water solution of pOPMA and ADH before and after the COSA. B and C) CryoSEM images and DLS size distribution plot of pOPMA nanogel. D) DLS size distribution plots of pOPMA nanogels prepared in the presence of SDS. Upper, middle and lower curves for COSA with SDS, COSA without SDS and SDS alone. E) Size and polydispersity index (PDI) of POPMA nanogels formed in the presence of salts (middle) and urea (right). F) Schematic depiction of FRET induced by the COSA of POPMA chains labeled with Alexa-555 and Alexa-647. G) Emission spectra of POPMA-bond Alexa-555 and Alexa-647 during COSA (excitation wavelength at 520 nm). The arrows show the evolution of the spectra with increasing duration (0 h to 24 h). H) Photograph of macroscopic pOPMA gels in water (pH 7.4), mouse serum and DMSO. I) SEM image of a pOPMA hydrogel. J and K) Needle injection and in situ gelation of pOPMA and ADH (mixed with rhodamine B for visualization) in mice.

FIG. 3 Size control of POPMA nanogels formed via the COSA by changing crosslinking rate. A) DLS size distribution plots of pOPMA nanogels synthesized at different crosslinking reaction rates. The reaction rate is characterized by the half-life (t_{1/2}) of ADH consumption. The resulting size distribution from left to right curves obtained for half-life (t_{1/2}) 6.72, 4.85, 2.71 and 1.01. B) Size (circles) and PDI (diamonds) of pOPMA nanogels formed at pH ranging from 5.0 to 7.4 (15 mg/ml of polymer, 20% or 30% of DC). C) Linear correlation between the size and the ratio of t_{1/2} of ADH consumption and t_{1/2} of the light scattering intensity (LSI) increase. R: linear correlation coefficient. Data include 20% and 30% DC.

FIG. 4 pOPMA microgels hierarchically assemble into porous scaffolds. A) Schematic illustration of the microfluidic fabrication of pOPMA microgels at high and low pH values of the dispersed phase, resulting in separate microgels or microgel fibers. B) Separate microgels (left) produced via microfluidics and SEM images of the microgels (right) show that they are composed of nanogels (bottom). C) pOPMA microgels self-assemble into a fiber in the microfluidic outlet (left), which is printed on a glass plate (right). D-G) SEM images of pOPMA microgel-based fibers (D) which are printed as planar (E) and 3D porous scaffolds (F and G). H) SEM image of L929 fibroblast cells spreading on the surface and in the pores of a pOPMA microgel-based fiber after modification with 2-(aminooxy) ethanamine.

FIG. 5. Detection of free pOPMA and ADH after COSA. A) GPC chromatograms of POPMA before (0 hour) and after nanogel formation (24 hours). B) HPLC chromatograms of ADH before (0 hour) and after nanogel formation (24 hours). Both free pOPMA and ADH are not detectable after 24 hours of crosslinking reaction between pOPMA and ADH.

FIG. 6. DLS size distribution of POPMA nanogels prepared in the presence of DMSO. 100% DMSO=only DMSO; 50% DMSO=water/DMSO (1/1, v/v); 25% DMSO=water/DMSO (3/1, v/v). Polymer concentration=15 mg/ml; degree of crosslinking=30%; temperature=23° C.

FIG. 7. DLS size distribution of pOPMA nanogels prepared in water at different temperatures. Polymer concentration=15 mg/ml; degree of crosslinking=30%; pH=6.5.

FIG. 8. DLS size distribution of POPMA nanogels prepared with different polymer concentrations. Degree of crosslinking=30%; pH=6.5; temperature=23° C.

FIG. 9. DLS size distribution of pOPMA nanogels prepared with different degrees of cross-linking.

FIG. 10. DLS size distribution of nanogels prepared with pOPMA of different molecular weights. Polymer concentration=15 mg/ml; degree of crosslinking=30%; pH=6.5; temperature=23° C.

FIG. 11. Stability of POPMA nanogels under different conditions. A) Incubation with 90% DMSO for 24 hours. B) Incubation with SDS (2.4 mg/mL) for 24 hours. C) Incubation in PBS 7.4 for 24 hours. D) Incubation with urea (30 mg/mL) for 24 hours. E) Incubation at 80° C. for 10 minutes. F) Treatment with ultrasound for 10 minutes.

FIG. 12. Characterization of POPMA after CTA removal and DLS of POPMA nanogels. A) UV absorption spectra of free CTA, POPMA before and after CTA removal. After the treatment, the signal of residual CTA group on pOPMA is not detected. B) DLS size distribution of pOPMA nanogels prepared with pOPMA without CTA. Polymer concentration=15 mg/mL; degree of crosslinking=30%; pH=6.5; temperature=23° C.

FIG. 13. Long-term stability of POPMA nanogels of different sizes stored at different temperatures (4° C. and 23° C.). A) Nanogels of 53 nm. B) Nanogels of 105 nm. The curves at 4° C. and 23° C. overlap.

FIG. 14. FRET efficiency between Alexa-555 and Alexa-647 during nanogel formation. Polymer concentration=15 mg/mL; degree of crosslinking=30%; temperature=60° C., molar ratio between Alexa-555 and Alexa-647=1/1.

FIG. 15. Stiffness of POPMA hydrogels with different polymer concentrations. Degree of crosslinking=100%; pH=6.5; temperature=23° C.

FIG. 16. Gelation time of POPMA hydrogels at different pH values. Polymer concentration=40 mg/mL; degree of crosslinking=100%; temperature=23° C.

FIG. 17. Sizes of POPMA nanogels with different concentrations of aniline. Polymer concentration=15 mg/ml; degree of crosslinking=30%; pH=6.5; temperature=23° C.

FIG. 18. Fluorescence emission spectra of Alexa-555/647-labeled pOPMA nanogels of 12 and 50 nm. Polymer concentration=15 mg/ml; degree of crosslinking=30%; excitation wavelength=520 nm.

FIG. 19. Half-life (t_{1/2}) of ADH consumption for COSA at different pH values. Polymer concentration=15 mg/ml; degree of crosslinking=30%; temperature=23° C.

FIG. 20. Half-life (t_{1/2}) of the increase of light scattering intensity for pOPMA crosslinking at different pH values. Polymer concentration=15 mg/ml; degree of crosslinking=30%; temperature=23° C.;

FIG. 21. Microfluidic chip used for pOPMA microgel fabrication.

FIG. 22. Aspect ratio of L929 cell cultured on pOPMA hydrogels with different degrees of AEA modification. Optimal growth of L929 cells on pOPMA hydrogels is achieved at 10% of AEA modification as indicated by the highest aspect ratio of the cells.

FIG. 23. Cytotoxicity of L929 cells cultured on pOPMA hydrogels with different degrees of AEA modification. pOPMA hydrogels with up to 30% of cationic modification with AEA does not display obvious cytotoxicity on L929 cells.

FIG. 24. Cytotoxicity of POPMA (Mn of 8.5 kDa) in L929 cells. poly-(N-(2-hydroxypropyl) methacrylamide) (pHPMA) (Mn of 8.4 kDa) and PEG (Mn of 8.0 kDa) are used as controls.

### DETAILED DESCRIPTION

The method according to the first aspect of the present invention comprises or consists of:
(a) providing polymer entities bearing covalently crosslinkable groups and respective crosslinker entities;
(b) bringing the polymer entities and the crosslinker entities in contact with each other in a solution under conditions that allow the polymer entities to aggregate or assemble into an ordered structure and be intermolecularly crosslinked in one step and/or one pot; and,
(c) optionally, recovering the at least one polymer aggregate.

The present invention provides a polymer aggregate produced by a mechanism in which the self-assembly is not separated from the crosslinking and thus may proceed essentially simultaneously. The method in particular finds use as a novel strategy to synthesize polymer aggregate(s) in the form of multi-scale hierarchical gel network(s). Surprisingly, the polymer aggregate, constituted from intermolecularly crosslinked polymer entities, has an ordered structure. This is in contrast to the expectation that crosslinking of polymers, in particular homopolymers, often leads to random aggregation and macro-scale gelation.

In contrast to non-covalent self-assembly, the covalent self-assembly is independent of and unaffected by solvent conditions (e.g., polarity and ionic strength) and does not require additional agents, e.g., organic solvents and surfactants. The covalent polymer self-assembly can be easily and tightly controlled by tuning the covalent crosslinking rate. This leads to polymer aggregates, in particular nanogels, that can be controlled to range in dimensions from less than 10 nm to far above 100 nm. Moreover, the crosslinking rate also regulates the assembly behavior of microgels fabricated by microfluidics. The microgels may self assemble into granular fibers, which can be 3-dimensionally printed into stable porous scaffolds, for instance. The novel covalent polymer self-assembly disclosed herein has enormous potential to provide polymer material across multi scales for applications in drug delivery, tissue engineering, and many other fields.

The polymer aggregates thus produced are very stable. For instance, treatment with an organic solvent, surfactant, salts, hydrogen bond interrupter, heating and ultrasound left them unaffected, indicating that the polymer aggregates are not based on weak non-covalent interactions but covalent bonds. Furthermore, adding surfactant, salts, and hydrogen bond interrupter during the covalent self-assembly does not affect the size of the produced polymer aggregates, showing that the self-assembly process is independent of the common non-covalent interactions (i.e., hydrophobic, charge and hydrogen bonding). The polymer aggregates show high colloidal stability for more than a month at 4° C. and room temperature.

The method can be carried out in the absence of surfactants, salts or solutes or mixed solvents. However, their presence does not conflict with the reaction either. Therefore, both possibilities (absence and presence of surfactants, salts or solutes or mixed solvents) are envisaged herein.

The crosslinkable groups are not particularly limited, and will mainly depend on the particular crosslinker entities to be employed. Preferred crosslinkable groups are selected from the group consisting of ketones, aldehydes, carboxylic acids and their derivatives, hydroxyls, amines, hydrazines, hydrazides, hydroxylamines, disulfides, maleimides, azides, alkynes, strained alkenes, tetrazines and tetrazoles. Ketone groups are particularly preferred. The crosslinkable groups are preferably in the repeating unit of the polymer entities. More specifically, at least 50%, at least 60%, at least 70%, at least 80%, at least 90%, at least 91%, at least 92%, at least 93%, at least 94%, at least 95%, at least 96%, at least 97%, at least 98%, at least 99%, or all of the repeating units may be crosslinkable.

The polymer entities may be substantially identical or different.

The polymer entities may broadly range in size. In particular, it is preferred that the polymer entities have a number averaged molecular weight (Mn) ranging from 1,000 to 500,000, preferably 2,000 to 100,000, more preferably 3,000 to 50,000, more preferably 4,000 to 20,000, most preferably 5,000 to 15,000, e.g., as determined by gel permeation chromatography.

Generally, the method of the invention accepts a variety of chemically different polymer entities. In a particularly preferred embodiment of the present invention, the polymer entities comprise or consist of poly(acrylates), poly(methacrylates), poly(acrylamides), poly(methacrylamides), poly(vinylethers) and derivatives thereof, preferably ketone-bearing poly(methacrylamides) and poly(acrylamides), in particular poly(N-(2-oxopropyl) methacrylamide) (pOPMA).

The crosslinker entities may have two or more crosslinking groups. If desired, the two or more crosslinking groups are spaced apart from each other by respective linkage(s), which may range from 1 to 1000 atoms, preferably 2 to 10 atoms, in length, wherein the number of atoms refer to a shortest or a straight chain of atoms between two crosslinking groups.

In other terms, atoms occurring in side branches of the connection between the two crosslinking groups do not add to the indicated range.

The crosslinks may be degradable or cleavable. To this end, crosslinker entities may be used that include a hydrazone, a disulfide and/or an ester bond, for example in the linkage(s), if present. In some embodiments, the crosslinks are in vivo degradable or in vivo cleavable. This embodiment is particularly preferred if the polymer aggregate is to be used as a drug delivery system. In this case, disassembling of the polymer aggregate (drug delivery system) due to degradation or cleavage of crosslinks releases the active ingredient in vivo.

Particularly preferred crosslinker entities are selected from the group consisting of ketones, aldehydes, carboxylic acids and their derivatives, hydroxyls, amines, hydrazines, hydrazides, hydroxylamines, disulfides, maleimides, azides, alkynes, strained alkenes, tetrazines and tetrazoles. In specific embodiments, the crosslinker entities comprise or consist of poly(N-(2-oxopropyl) methacrylamide) (pOPMA).

A further preferred embodiment provides polymer aggregates in which 5 to 100% of the repeating units (of the polymer entities) are crosslinked. As further detailed below, it was found that at low degrees of crosslinking (DC), the self-assembly may be completed at the nanoscale, whereas at higher degrees of crosslinking, the nanoscale aggregate particles may undergo inter-particle crosslinking to form micro- and macro-scale structures.

The solution in which the covalent self-assembly is carried out is not particularly limited, as long as the polymer entities and the crosslinker entities are sufficiently soluble therein. Specific solutions mentioned herein comprise or consist of water, buffers, acetone, ethyl acetate, hexane, heptane, dichloromethane, methanol, ethanol, tetrahydrofuran, acetonitrile, dimethylformamide, N,N-dimethylacetamide, toluene, dimethylsulfoxide and mixtures thereof.

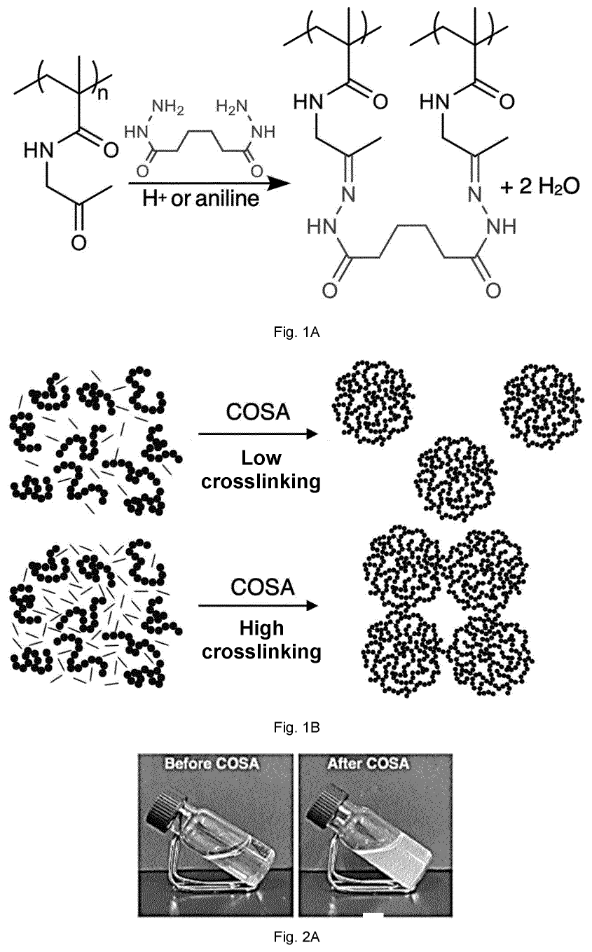

The polymer entities undergo self-assembly to form ordered polymer aggregates at nanoscale to macro-scale. Particularly, the produced polymer aggregate(s) may be selected from the group consisting of nanoparticles, microstructures and macrostructures. The nanoparticles may be directly synthesized via crosslinking of the polymer entities. During bond formation between the polymer entities and the crosslinker entities, at least a fraction of crosslinking occurs intermolecularly, which leads to self-assembly of polymer chains (FIGS. 1A, 1B). At low degrees of crosslinking (DC), the self-assembly may be completed at the nanoscale and well-defined nanoparticles are yielded. At higher degrees of crosslinking, the nanoparticles undergo inter-particle crosslinking to form micro- and macro-scale structures. Hence, the microstructures and macrostructures may be composed of nanoparticles.

The polymer aggregates can assume a variety of different shapes. For instance, the nanoparticles can be spherical, whereas the spheres can assemble into various 3-dimensional shapes including fibers. The prefixes “nano”, “micro” and “macro” refer to structures ranging in size from 1 nm to 999 nm, 1 μm to 999 μm, and 1 mm or above, respectively. Preferably, the nanoparticles range in size from 5 nm to 999 nm, preferably from 8 to 150 nm. If plural nanoparticles are produced, the size range preferably refers to the D50 or D90 diameter. Further, if plural nanoparticles are produced, a polydispersity index (PDI) of below 0.7, preferably below 0.5, more preferably below 0.3 is preferred, e.g., as determined by dynamic light scattering (DLS).

Another advantage of the present method is its tight control. In particular, the size of the produced polymer aggregate(s) can be modulated via concentration of polymer entities, concentration of crosslinker entities, molecular weight of polymer entities and/or crosslinking rate. The crosslinking rate in turn can be controlled via catalyst concentration and temperature. The crosslinking rate-controlled size modulation is assumed to be due to the change of the ratio between intramolecular and intermolecular crosslinking. When polymer chains collide during the crosslinking reaction, the chance of intermolecular crosslinking is higher at faster reaction rates, which leads to the scenario that more chains are crosslinked together and therefore larger aggregates are formed. At slower reaction rates, the chance of intermolecular crosslinking is lower, which results in smaller structures.

If the covalent self-assembly is conducted in an aqueous solution, the pH value preferably ranges from 3.0 to 9.5, more preferably from 5.0 to 8.5. This is in particular so, if dihydrazides are used as crosslinker.

The method of the invention enables covalent self-assembly using microfluidics via flow focusing droplet formation. For example, the polymer entities and the crosslinker entities are brought in contact with each other by injecting a solution of the polymer entities and a solution of the crosslinker entities into a microfluidic device through separate inlets. The injected solutions will rapidly mix and the covalent self-assembly will immediately start. The injected and mixed solutions can then be cut by a phase that is immiscible with the mixed solutions of polymer entities and crosslinker entities, such as an oil phase in the case of aqueous solutions. Depending on the crosslinking rate, the polymer entities and the crosslinker entities self-assemble to form separate microparticles (droplets) or a covalently connected chain of microparticles (fiber(s)), which can then be recovered at an outlet of the microfluidic device.

Fibers recovered at the microfluidic outlet may be used in 3-dimensional printing techniques. Thereby, macroscopic planar and mechanically stable free-standing 3-dimensional porous scaffolds composed of multiple layers of fibers can be obtained. The porous scaffolds are high potential materials for tissue engineering. The surface or interior of the polymer aggregate(s) can be functionalized. One example of such functionalization confers cell adherence properties to the polymer aggregate(s). For example, to increase interaction with cells, the scaffolds may be modified with functional groups to promote cell attachment and growth. For example, introduction of cationic-NH₃⁺ groups or cell-binding ligands to the scaffolds allows fibroblast cells incubated with the scaffolds to adhere to and to spread on the surface and in the pores of the scaffolds.

The principles of the present invention can be exploited in various other applications. For example, the polymer entities and the crosslinker entities can be brought in contact with each other by injecting a solution of the polymer entities and a solution of the crosslinker entities into a(ny) reservoir, even a biologic reservoir, to be filled with, to be supported by and/or to be sealed by the polymer aggregate(s).

As already stated, the polymer aggregate(s) are well suited for drug delivery. Accordingly, in a further embodiment, the polymer aggregate(s) is/are loaded with a bioactive agent. The bioactive agent may be added before, during, or after the covalent self-assembly (step (b)).

Another aspect of the present invention pertains to polymer aggregate(s), produced according to the method of the invention or according to an embodiment thereof. A 3-dimensional porous scaffold, produced according to the method of the invention or according to an embodiment thereof, is a further aspect of the invention.

The present invention will now be further described with reference to the following examples and the accompanying drawings.

### EXAMPLES

The present disclosure relates to a covalent polymer self-assembly process. The feasibility of the new approach, in the following also referred to as covalent crosslinking-driven self-assembly (COSA), was demonstrated by employing a ketone homopolymer as an example, which shows a self-assembly behavior of the polymer entities during crosslinking with dihydrazide crosslinker entities. However, the process is not limited to this specific polymer and/or to this specific crosslinker, but generally applicable to all kind of crosslinkable polymers.

### 1. Materials

N-(2-oxopropyl) methacrylamide (OPMA) was synthesized as reported in Shi Y., van Nostrum C. F., and Hennink W. Interfacially Hydrazone Cross-linked Thermosensitive Polymeric Micelles for Acid-Triggered Release of Paclitaxel. ACS Biomater. Sci. Eng. 2015, 1, 393-404. Fetal bovine serum, penicillin/streptomycin and phosphate buffered saline (PBS) were ordered from Life Technology (Germany). L929 mouse-derived fibroblasts were purchased from Deutsche Sammlung von Mikroorganismen und Zellenkulturen GmbH, DSMZ ACC-2. RPMI 1640 medium was ordered from Gibco, Life Technologies GmbH (Germany). ABIL EM 90 was purchased from Evonik (Germany). Millipore water was used throughout the experiments. All other substances, kits and disposables were obtained from global suppliers.

### 2. Methods

### 2.1 Synthesis of poly(N-(2-oxopropyl)methacrylamide)

Poly(N-(2-oxopropyl) methacrylamide) (pOPMA) was synthesized via reversible addition-fragmentation chain transfer (RAFT) polymerization of OPMA in water.

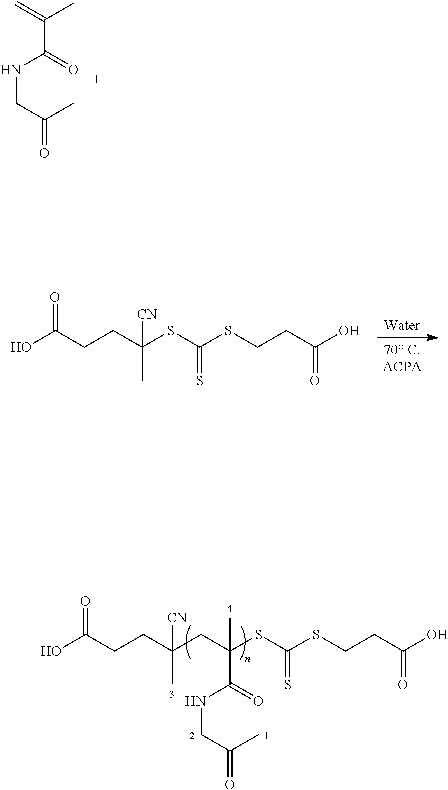

The method was adapted from Shi Y et al., supra. Specifically, 4,4′-azobis(4-cyanopentanoic acid) (ACPA) was used as the free radical initiator and CTCA was employed as the chain transfer agent (CTA). The reaction solutions were degassed by three cycles of freeze-pump-thaw. The polymerization was carried out at 70° C. in a Schlenk tube under N₂ atmosphere and stirring. The concentration of the monomer was 300 mg/mL. The molar ratio of monomer/CTA/initiator was 600/5/1 to 300/5/1. At pre-set time points, samples were taken to quantify monomer conversion using proton nuclear magnetic resonance (1H NMR spectroscopy, Bruker, 600 MHZ FT NMR, Germany) by comparing the vinyl protons of OPMA at 5.35 ppm and the protons of the amide groups of POPMA at 7.53 ppm. The molecular weights of POPMA in the samples were measured by gel permeation chromatography (GPC) using two serial PLgel 5 μm MIXED-D columns (Polymer Laboratories, UK) with dimethylformamide (DMF) (containing 10 mM lithium chloride (LiCl)) as the eluent. The polymer was purified by dialysis against water for 24 hours and dried by lyophilization (BUCHI, Lyovapor L-200, Switzerland). For free radical polymerization, OPMA and ACPA were dissolved in water and the reaction solutions were degassed by bubbling N₂ for 15 minutes. The free radical polymerization was conducted at 70° C. under N₂ atmosphere and stirring.

### 2.2 Solubilization of Products from OPMA Polymerization

The polymer products yielded from RAFT polymerization of OPMA and the gelled solid products from free radical polymerization were mixed with common laboratory solvents, i.e., water, acid (1 M hydrochloric acid), base (1 M sodium hydroxide), methanol, acetonitrile (ACN), DMSO, DMF, dimethylacetamide (DMAc) and dichloromethane (DCM). ˜4 mg of the products was added in 1 mL of the solvents. The solids from free radical polymerization in the solvents were heated and sonicated.

### 2.3 Nanogel/Nanoparticle Formation Via the COSA of POPMA

pOPMA and the crosslinker adipic acid dihydrazide (ADH) were dissolved separately in water. The polymer and crosslinker solutions were mixed and kept under stirring at 1000 rpm at room temperature (RT, 23° C.) for 24 hours. The final concentrations of POPMA in the mixtures were 10, 15 or 20 mg/mL and the concentrations of ADH varied between 0.93 and 3.7 mg/mL, depending on the feed degree of crosslinking (i.e., the molar ratio of hydrazide to ketone). 30% degree of crosslinking was used for all three concentrations of POPMA. In addition, 10, 20 and 40% degree of crosslinking was employed for pOPMA at 15 mg/mL. pOPMA nanogel formation was also performed in water solutions containing SDS (2.4 mg/mL), PBS salts (NaCl at 137 mM, KCl at 2.7 mM, Na₂HPO₄ at 10 mM and KH₂PO₄ at 1.8 mM) or urea (30, 60 and 300 mg/mL). To test the formation of nanogels in the presence of organic solvents, pOPMA and ADH solutions were prepared in DMSO or DMSO/water co-solvents (50 and 25% of DMSO in water). To study the formation of nanogels at different temperatures, the COSA of POPMA was conducted at 23, 35 and 50° C. To assess nanogels formation from pOPMA with different molecular weights, polymers with Mn of 8.5, 12.8 and 16.9 kDa (measured by GPC) were used.

### 2.4 Nanogel Formation from pOPMA without CTA Residual Group

The residual group of CTA on pOPMA was removed by reacting with a large access of free radicals. pOPMA (300 mg) and ACPA (50 mg) were dissolved in 1 mL DMSO and the solution was bubbled with N₂ for 15 minutes. The reaction was conducted at 70° C. for 24 hours. The polymer was isolated and purified by precipitation in diethyl ether for 3 times, and dried at RT for 48 hours. The resulting pOPMA was analyzed by UV-vis spectroscopy using a Tecan reader (Life Science, infinite 200 PRO, Germany), and the absorbance spectrum was compared to that of POPMA before CTA removal and CTA. POPMA without CTA residual group was used to prepare nanogels using the protocol described above.

### 2.5 Physico-Chemical Characterizations of POPMA Nanogels

pOPMA nanogels were analyzed by dynamic light scatter (DLS, Malvern Panalytical, Zetasizer, UK) and cryo-field emission scanning electron microscopy (CryoSEM, Hitachi, Su-4800, Japan). pOPMA nanogels dispersions were filtered through 0.2 μm nylon membranes, and the size and polydispersity index (PDI) of nanogels were recorded by DLS. For CryoSEM analysis, 10 μL of nanogels dispersions were placed on a rivet and frozen in liquid nitrogen, which were subsequently visualized using CryoSEM.

2.6 Detection of Residual ADH and pOPMA after Nanogel Formation

pOPMA nanogels were prepared with 15 mg/ml of POPMA, 30% degree of crosslinking at pH 6.5. 10 μL of the dispersion was diluted 10-fold in water (with 0.1% formic acid) which was immediately analyzed by HPLC for ADH. The eluent was 20% ACN (0.1% formic acid) and 80% water (0.1% formic acid) and an Agilent Prep-C18 Scalar column (5 μm, 4.6×150 mm) was used. The elution time of ADH was 3 minutes. For GPC analysis of residual POPMA after nanogel formation, 10 μL of the pOPMA nanogel dispersion was mixed with 90 μL of DMF (10 mM LiCl). The sample was immediately analyzed using the GPC protocol described above.

### 2.7 Stability of POPMA Nanogels Under Different Conditions

The pOPMA nanogels (15 mg/mL pOPMA, 30% degree of crosslinking, pH 6.5) were prepared in water and aliquoted. 100 μL of nanogels were mixed with 900 μL of PBS (pH 6.5), SDS (final concentration of SDS at 2.4 mg, above the critical micelle concentration of SDS), urea (30 mg/mL) or DMSO for 24 hours. pOPMA nanogels were also treated by physical stimuli including ultrasound (60 W for 10 minutes) or heating at 80° C. for 10 minutes. After the treatments, sizes and PDI of the nanogels were measured by DLS.

### 2.8 Nanogels Formation in the Presence of SDS, Salts and Urea

pOPMA nanogels were prepared in water with 15 mg/mL polymer and at 30% degree of crosslinking, to which SDS (2.4 mg/mL), PBS salts or urea (30, 60 and 300 mg/mL) were added. The nanogels were formed under the same conditions described above and the yielded nanogels were analyzed by DLS for size and PDI.

### 2.9 Long-Term Stability of POPMA Nanogels

POPMA nanogels of 53 and 105 nm with PDI of 0.21 and 0.22 were prepared in PBS and incubated at room temperature (23° C.) and 4° C., and the samples were measured by DLS every 7 days.

### 2.10 Fluorophore Labeling of POPMA

POPMA was labeled with Alexa-555 hydrazide or Alexa-647 hydrazide. The fluorophore was added to pOPMA (10 mg) with a molar ratio of fluorophore/ketone at 1:1000 in methanol, and 1 μL of acetic acid was used as a catalyst. Fluorophore-modified pOPMA was purified by dialysis (molecular cutoff of 3.5 kDa) against water. After purification, the fluorophore-modified polymers were lyophilized and analyzed by GPC with a UV-Vis detector (detection at 520 nm for Alexa-555; 635 nm for Alexa-647). Free Alexa-555 hydrazides and Alexa-647 hydrazides were injected separately as controls.

### 2.11 Förster Resonance Energy Transfer (FRET)

Alexa-555-labeled pOPMA (1.87 mg), Alexa-647-labeled pOPMA (1.88 mg) and pOPMA (11.25 mg) were dissolved in DMSO, to which ADH (2.8 mg) was added. The mixture was stirred at 60° C. or RT. At pre-set time points from 0 to 24 hours, 10 μL samples were taken and mixed with 90 μL of DMSO. The emission spectra of the solutions, as well as those of Alexa-555/647-labeled pOPMA were recorded using a fluorometer. The excitation wavelength was 520 nm and the emission spectra were recorded between 530 and 750 nm. The FRET efficiency was calculated as follows (F674: fluorescence emission intensity at 674 nm; F570: fluorescence emission intensity at 570 nm):

$$FRET efficiency = \frac{F 674}{F 570 + F 674}$$

### 2.12 Nanogel Size Modulation by Changing pH or Adding Aniline

For pOPMA nanogel preparation at different pH values, 15 mg/mL polymer was mixed with ADH (at 20% or 30% degree of crosslinking) in PBS at pH ranging from 5.0 to 7.4. The solutions were kept on stirring for 24 hours. The nanogels were filtered and analyzed as described above. For aniline addition experiment, in 15 mg/mL polymer mixed with ADH (30% degree of crosslinking) in PBS 6.5, aniline in PBS 6.5 was added with concentrations at 15 or 30 mg/mL. The nanogels were prepared and analyzed as described above.

### 2.13 Characterization of Crosslinking by HPLC and DLS

During pOPMA nanogel formation in PBS 6.5 at 15 mg/mL polymer and 20/30% degree of crosslinking, samples were taken during the first 24 hours. At each time point, 10 UL of the samples were mixed with 90 μL of water (0.1% formic acid) and the samples were immediately measured by HPLC using the method described above. For DLS measurement of the light scattering intensity (LSI) of the nanogel dispersions, 100 μL of samples were taken and diluted 10-fold in water, which were immediately measured by DLS.

### 2.14 pOPMA Gelation

POPMA and ADH solutions in water or PBS (pH ranging from 3.0 to 8.5), serum or DMSO were mixed with a 1/1 volume ratio. pOPMA solutions with concentrations ranging from 1.5 mg/mL to 300 mg/mL) and ADH solutions with concentrations ranging from 0.93 mg/ml to 187 mg/mL were used. The final polymer concentrations were between 0.75 and 300 mg/mL, and the degree of crosslinking was 100%. The mixtures were added in cylindrical molds or in glass vials, and were kept still until the solutions were solidified.

### 2.15 SEM Analysis of POPMA Hydrogels

POPMA hydrogels (500 μL, 100% degree of crosslinking) were dried via a water and ethanol gradient method. The dried hydrogels were coated with gold by a sputtering coating system (Quorum Technologies Ltd., Polaron E5100, UK). The samples were analyzed by SEM (Philips, FEI ESEM XL30 FEG, The Netherlands).

### 2.16 Stiffness Measurement of POPMA Hydrogels

POPMA hydrogels were prepared in a cylindrical mold at pH 6.5 for 24 hours at RT. The elastic moduli (E) of the hydrogels were measured using dynamic mechanical analysis (DMA 2980, TA Instruments, DMA 2980, USA) with a controlled force mode. The force pump (from 0.001 to 1.0 N, rate of 0.1 N/minute) was used at 23° C.

### 2.17 In-Situ Gelation of POPMA in Mice

40 mg of POPMA were dissolved in 500 μL PBS 7.4 and rhodamine B (0.5 mg/mL) was added for visualization. 24.9 mg of ADH were dissolved in 500 μL PBS with rhodamine B (0.5 mg/mL). The polymer and ADH solutions were mixed and drawn in a syringe (2 mL), which was substantially injected in a freshly postmortem mouse kept at 37° C. After 5 minutes, the skin at the injection site was opened with surgical scissors to expose the insitu formed hydrogel.

### 2.18 Microfluidic Preparation of Microgels

Two separate solutions of POPMA (80 mg/mL) and ADH (49.6 mg/mL) were prepared in PBS 7.4 or 6.5. The polymer and crosslinker solution were injected into two separate inlet channels in a microfluidic chip at a speed of 30 μL/hour. The two phases were mixed in the chip and the mixture was cut by an oil phase (hexadecane and paraffin oil (v/v=1/1) with 2% ABIL EM 90 as the surfactant) at a speed of 120 μL/hour. pOPMA microgels or microgel fiber-based structures were collected and washed with n-hexane, isopropanol and water to remove residual oil phase on the materials.

### 2.19 Microgel Analysis by SEM

POPMA microgels were dried via a water and ethanol gradient method. The dried microgels were coated with gold by coating a sputtering system. The samples were imaged by SEM.

### 2.20 Cationic Modification of pOPMA Hydrogels or Microgel Fibers with AEA

pOPMA hydrogels or microgel fibers (˜3 mg) were incubated with 2-(aminooxy) ethanamine (AEA) in 1 mL methanol. The molar ratio between AEA and the hydrazone groups in the microgels ranged from 1/100 to 30/100. The modification reaction was kept at room temperature overnight. Afterwards, the solvent was discarded and the samples were washed with water for three times.

### 2.21 L929 Cell Growth on Hydrogels with Cationic Modification

L929 cells were seeded into 24-well plates at a density of 5*10³ cells/well and incubated with hydrogels with different degrees of AEA modification. After 7 days, the supernatants were transferred into an Eppendorf tube and centrifuged at 14,000 g for 30 minutes. The supernatants were analyzed via lactate dehydrogenase (LDH) assay for cytotoxicity. 100 μL of the supernatant were mixed with 100 μL of LDH solution and incubated at room temperature for 30 minutes. Absorbance was measured at 490 nm against a reference wavelength at 600 nm using a Tecan reader. The cells were stained by Actistain 488 Phalloidin and DAPI. The morphology of the cells was recorded by fluorescence microscopy (Carl Zeiss, Axio Imager M2 microscopy system, Germany). The aspect ratio of cells was calculated by image J (Image J2, USA).

### 2.22 Adhesion of L929 Cells on pOPMA Microgel Fibers

Microgel fibers with 10% AEA modification were sterilized in 75% ethanol for 5 minutes and washed by PBS 7.4 for three times. In 24-well plates, the microgels were incubated with L929 cells (5*10³) for 7 days. Microgel fibers incubated with L929 cells were fixed in methanol for 20 minutes. The morphology of the cells on the fibers was recorded by SEM.

### 2.23 Cytotoxicity of the Polymers

L929 cells were cultured in 96 well plates (5*10³ cells/well) overnight, and 100 μL of polymer (pOPMA, poly(ethylene glycol) (PEG, Mn of 8.0 kDa) and poly-(N-(2-hydroxypropyl) methacrylamide) (pHPMA)) solutions at different concentrations were added to cells.

The cells were incubated for 72 hours and cell viability was evaluated by 2,3-bis-(2-methoxy-4-nitro-5-sulfophenyl)-2H-tetrazolium-5-carboxanilide (XTT) assay. At the end of incubation, cells were washed with PBS and 100 μL of XTT solution were added to each well, followed by incubation at 37° C. for 4 hours. Absorbance was measured at 450 nm against a reference wavelength at 650 nm using a Tecan reader.

### 3. Results and Discussion

### 3.1 Ketone Homopolymer Synthesis and Crosslinking

The polymer pOPMA is prepared from N-(2-oxopropyl) methacrylamide (OPMA) by reversible addition fragmentation chain transfer (RAFT). The monomer conversion reaches 98% at 24 hours, and pOPMA with a Mn of 8.5 kDa and D of 1.1 is obtained. The product is highly soluble in water and organic solvents (data not shown).

POPMA undergoes highly controlled self-assembly to form hydrogels at nano- to macroscale. pOPMA nanogels are directly synthesized via crosslinking of the polymer with adipic acid dihydrazide (ADH, FIG. 1A). During hydrazone bond formation between pOPMA and

ADH, a fraction of crosslinking occurs intermolecularly, which leads to self-assembly of polymer chains (FIG. 1B). Our work shows that at low degrees of crosslinking (DC), the self-assembly is completed at the nanoscale and well-defined nanogels are yielded. At higher degrees of crosslinking, the nanogels undergo inter-particle crosslinking to form micro- and macro-scale hydrogels (FIG. 1B).

### 3.2 COSA Leads to Nano- to Macro-Scale Hydrogels

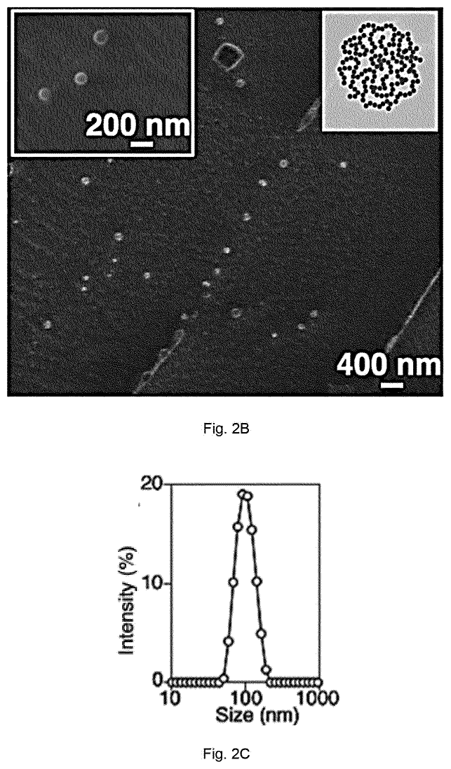

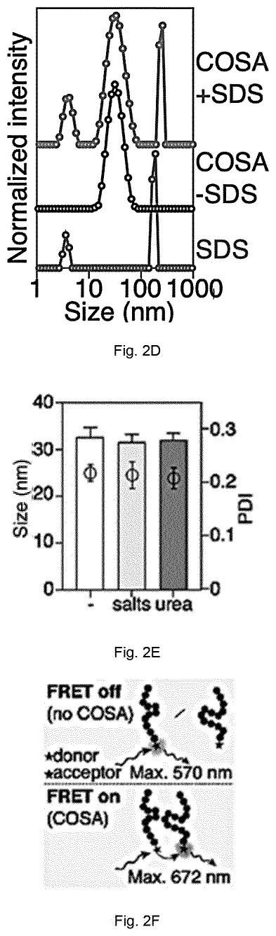

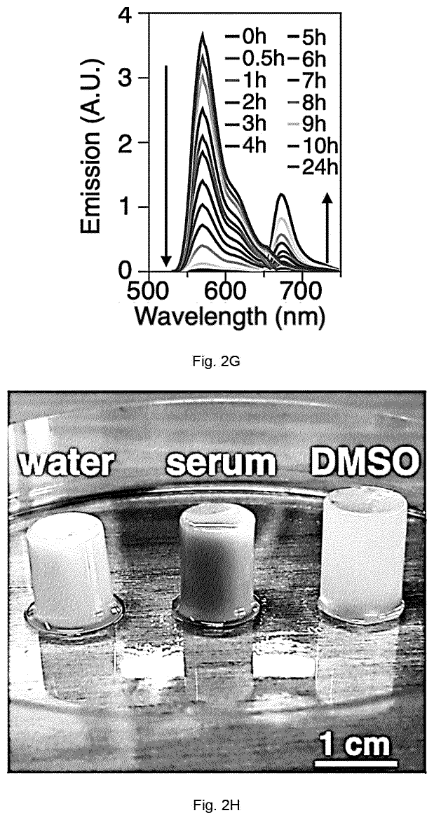

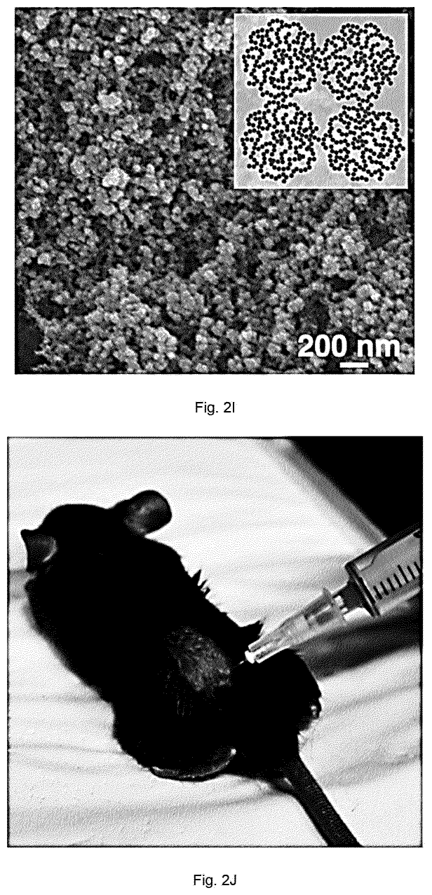

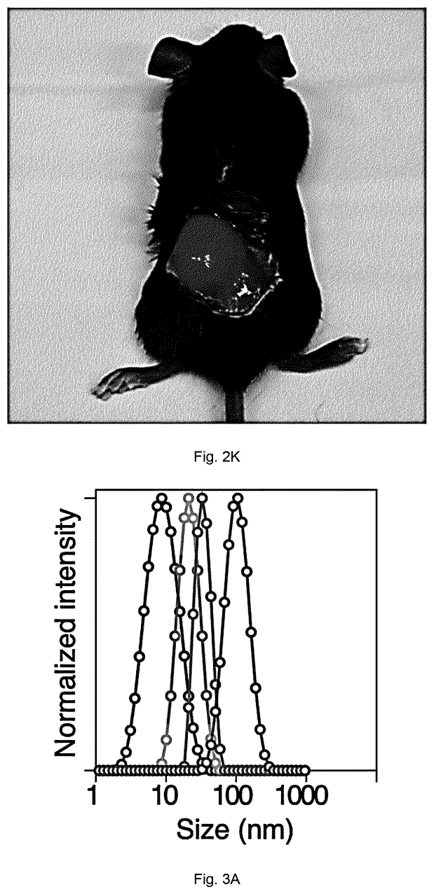

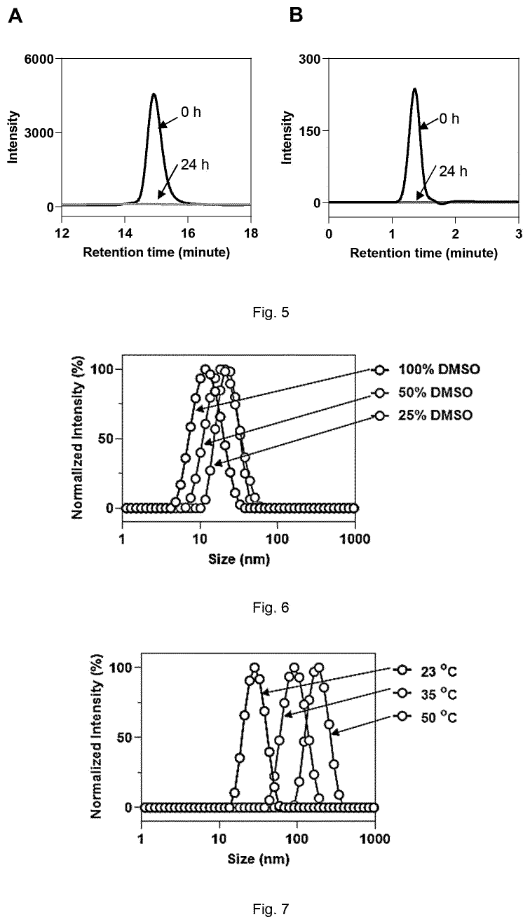

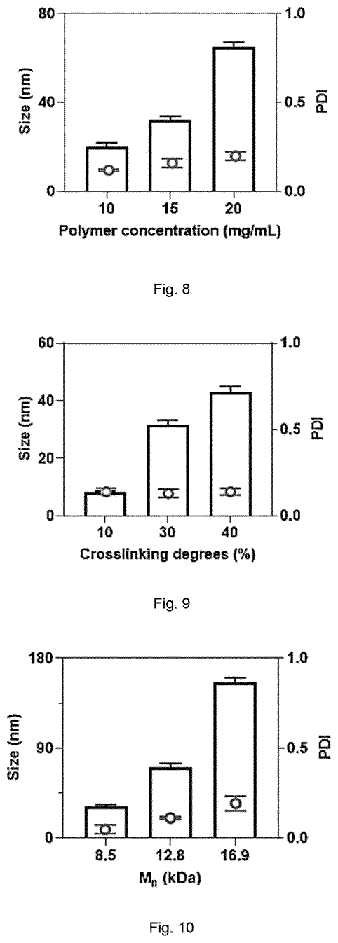

We first demonstrate the nanogel formation via the COSA of POPMA. The polymer at 15 mg/mL is crosslinked with ADH in water at pH 5.0. The DC is 20%, i.e., the feed molar ratio between hydrazide and ketone is 1/5. The crosslinking results in an opalescent dispersion (FIG. 2A). The sample is characterized by cryo-field emission scanning electron microscopy (CryoSEM) and dynamic light scattering (DLS). Both techniques support well-defined nanogel formation (FIG. 2B to C). The reaction is highly efficient and after the nanogelation residual free ADH and pOPMA are not detected (FIG. 5). The COSA of POPMA occurs in solvents with different polarities (water, DMSO and water/DMSO cosolvents, FIG. 6) and at different temperatures (FIG. 7), as well as at different polymer concentrations (FIG. 8), degrees of crosslinking (FIG. 9) and with pOPMA of different molecular weights (FIG. 10).

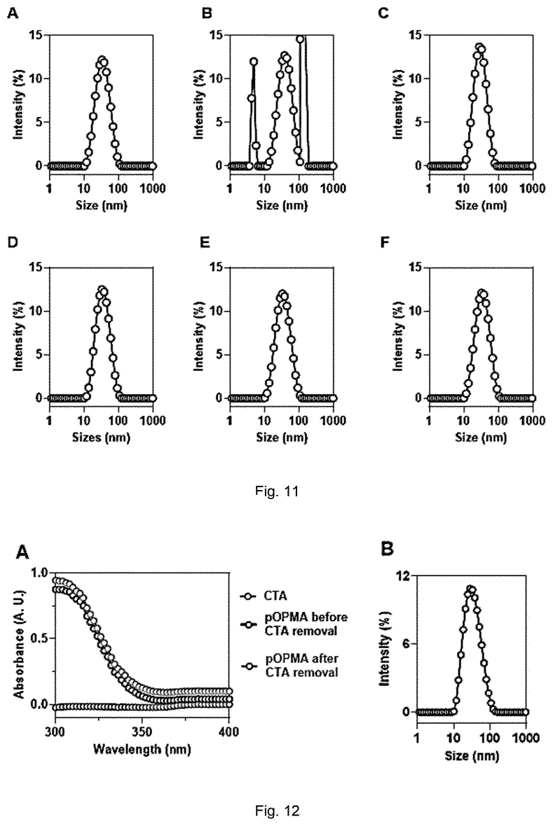

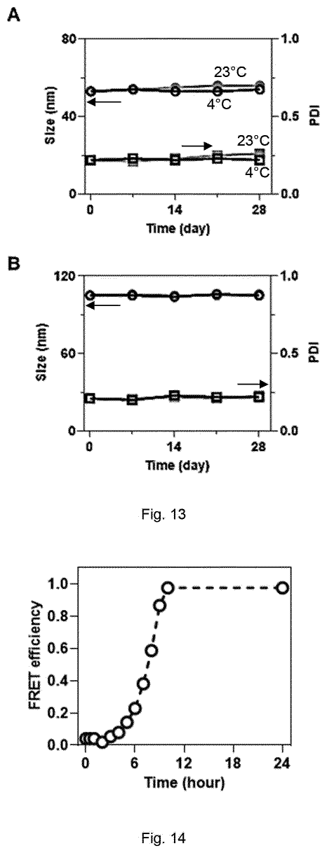

pOPMA nanogels are stable after different treatments, i.e. with an organic solvent (DMSO), surfactant (sodium dodecyl sulfate, SDS), salts (NaCl, KCl, Na₂HPO₄ and KH₂PO₄), hydrogen bond interrupter (urea), heating and ultrasound (FIG. 11). These findings indicate that the nanogels are not based on weak non-covalent interactions but covalent bonds. Furthermore, adding SDS, salts and urea during the COSA of POPMA does not affect the size of the nanogels, showing that the self-assembly process of pOPMA is independent of the common non-covalent interactions (i.e., hydrophobic, charge and hydrogen bonding, FIG. 2D to E). Also, removal of the chain transfer agent end group on pOPMA did not affect the size of formed nanoparticles (FIG. 12). pOPMA nanogels show high colloidal stability for more than a month at 4° C. and room temperature (FIG. 13). We monitor the self-assembly process of POPMA by Förster resonance energy transfer (FRET, FIG. 2F) with Alexa-555- and Alexa-647-labeled pOPMA. The FRET effect between the two fluorophores gradually increases during COSA, illustrating the self-assembly process of the polymer chains (FIG. 2G), which plateaus at 10 hours of reaction (FIG. 14).

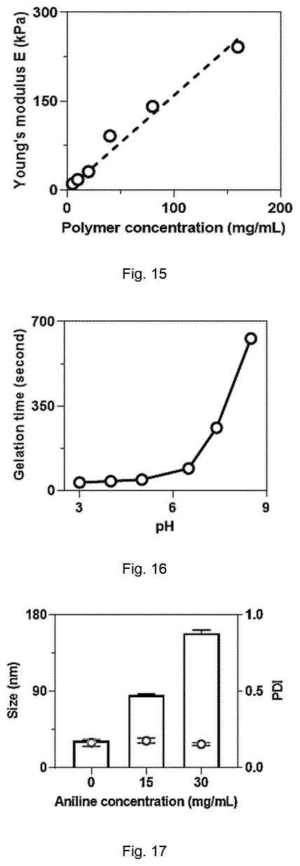

When increasing the DC, macroscopic gels are obtained in aqueous and organic solvents at 100% DC and 40 mg/mL polymer (FIG. 2H). The macro-scale gels are composed of pOPMA nanogels (FIG. 2I). pOPMA has a remarkably broad range of gelation concentration, from 300 to 0.75 mg/mL (100% DC, in PBS 6.5), and forms hydrogels with a great range of stiffness (FIG. 15). In aqueous media, the gelation time of POPMA is pH dependent since H⁺ catalyzes the crosslinking reaction. The gelation time is highly tunable in the biologically relevant pH range from 5.0 to 8.5 (FIG. 16).

Hydrogel formation occurs in less than 5 minutes upon subcutaneous co-injection of OPMA and ADH solutions in mice (FIG. 2J to K).

### 3.3 Nanogel Size is Controlled by Crosslinking Reaction Rate

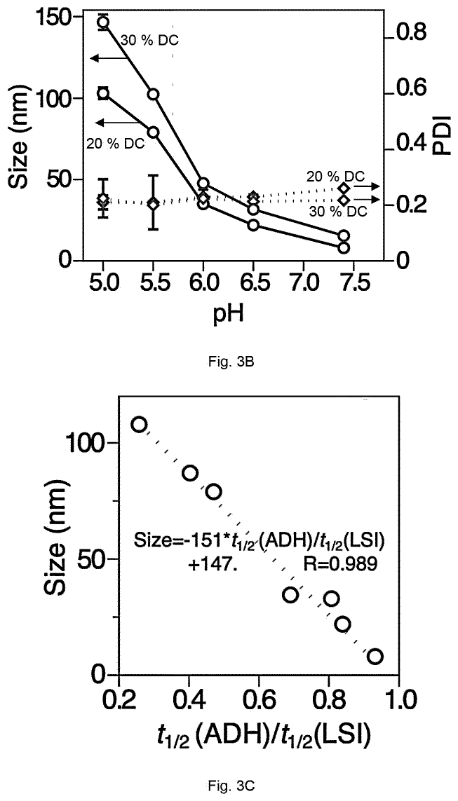

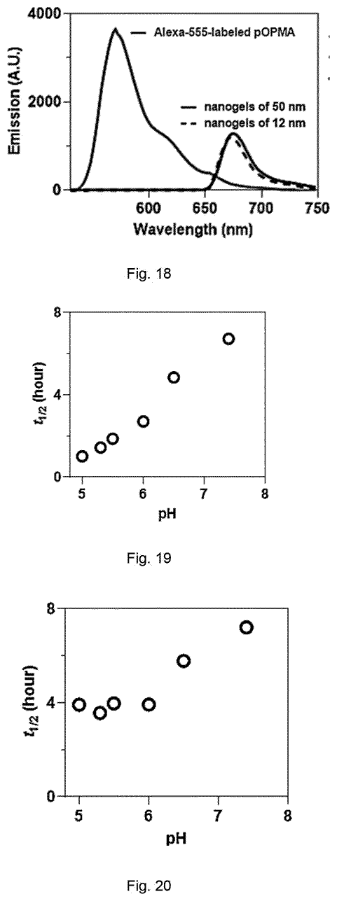

The size of POPMA nanogels is easily controlled in the range of <10 nm to >100 nm by tuning the crosslinking reaction rate (FIG. 3A). The crosslinking reaction rate and the size of yielded nanogels are modulated by regulating the pH (from 5.0 to 7.4; FIG. 3B). The size modulation also works by adding an organic catalyst, aniline, to promote hydrazone formation (FIG. 17). We obtain pOPMA nanogels (15 mg/mL polymer) with sizes between 8 and 103 nm (20% DC), or 15 to 147 nm (30% DC), at the pH value ranging from 7.4 to 5.0. pOPMA nanogels of small and large size have similar levels of FRET between pOPMA bound Alexa-555 and Alexa-647 (FIG. 18), indicating that the small nanogels are based on multiple polymer chains but not on intramolecularly crosslinked single polymer chains.

The crosslinking rate-controlled size modulation is proposed to be due to the change of the ratio between intramolecular and intermolecular crosslinking. When polymer chains collide during the crosslinking reaction, the chance of intermolecular crosslinking is higher at faster reaction rates, which leads to the scenario that more chains are crosslinked together and therefore larger nanogels are formed. At slower reaction rates, the chance of intermolecular crosslinking is lower, which results in smaller nanogels. The size tuning of pOPMA nanoparticles is a well-controlled process with a linear correlation (FIG. 3C, R=0.989) between size and the ratio of t_{1/2} of ADH consumption (FIG. 19) and t_{1/2} of the light scattering intensity (LSI) increase during COSA (FIG. 20). The size of nanogels with 30% DC also fits well in the correlation derived from nanogelation at 20% DC (FIG. 3C).

### 3.4 Covalent Microgel Self-Assembly for 3D Printing

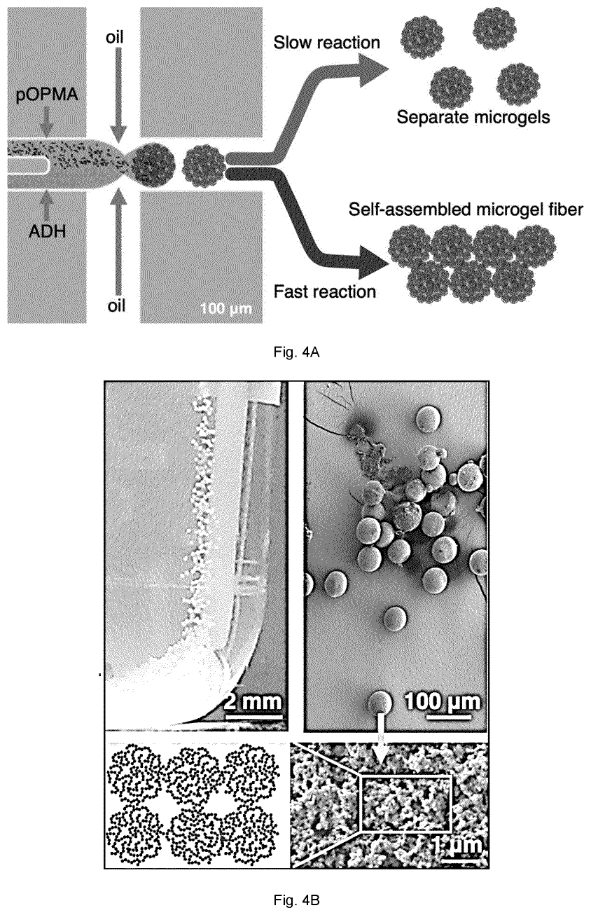

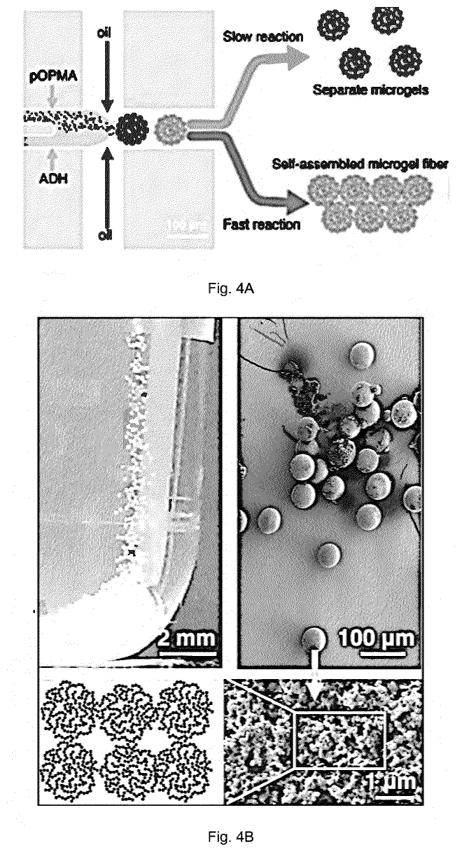

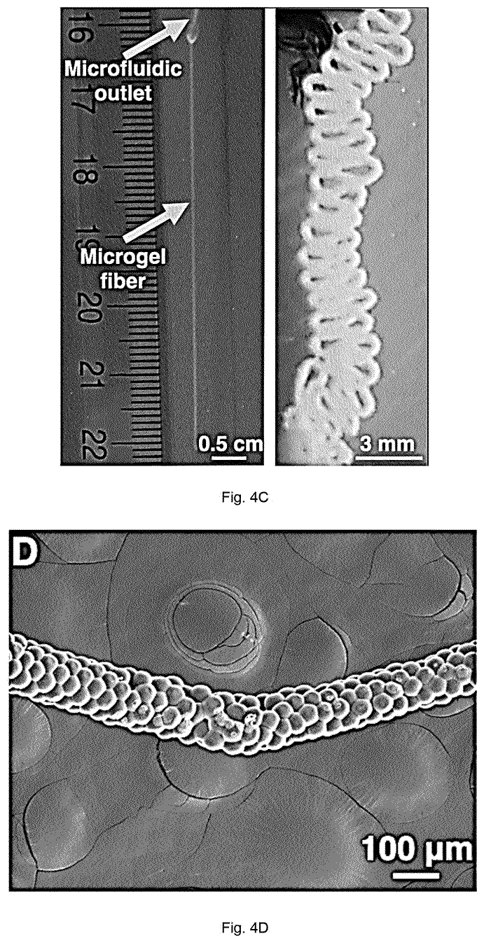

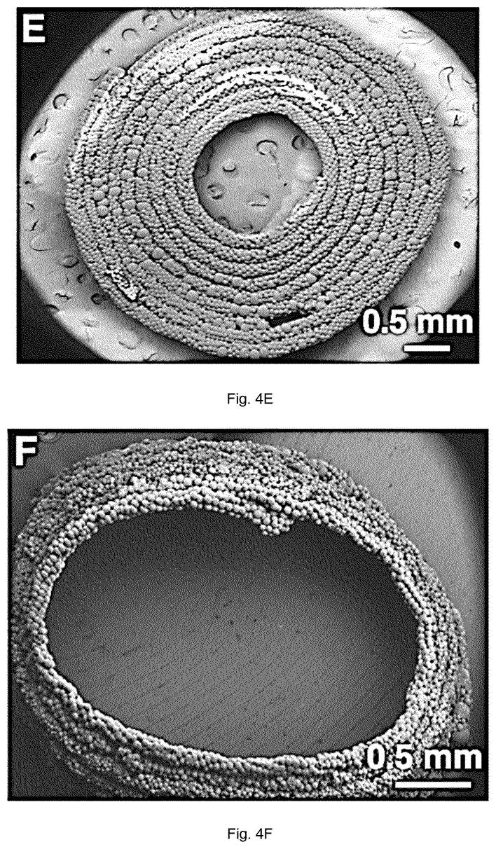

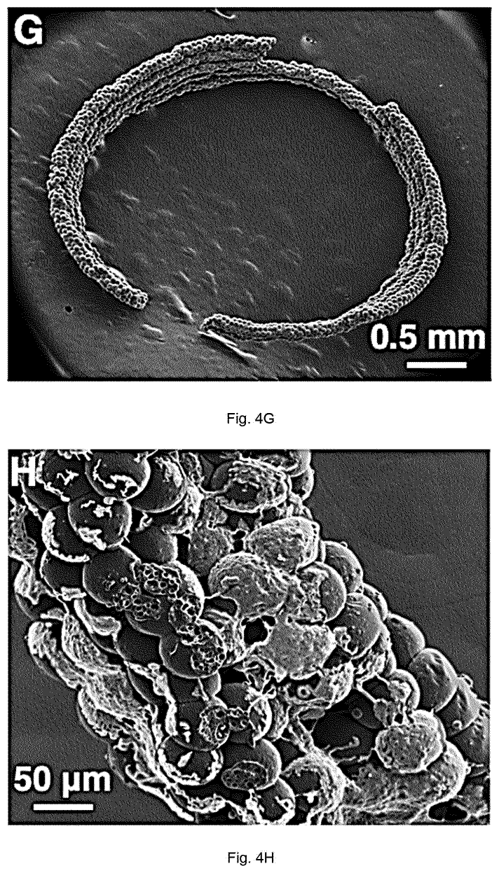

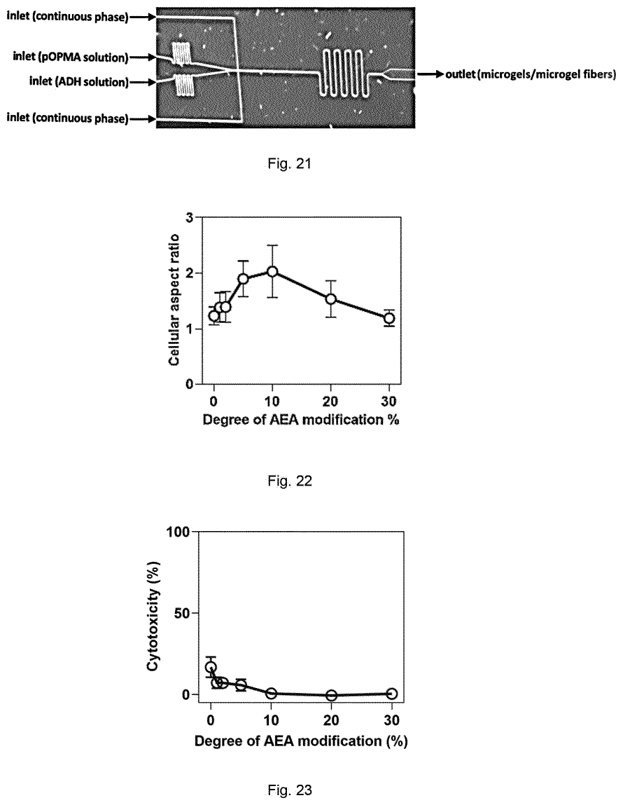

The COSA enables covalent self-assembly of POPMA microgels prepared using microfluidics via flow focusing droplet formation (FIGS. 4A and 21). pOPMA and ADH solutions are separately injected in two inlets, which are mixed and then cut by a continuous oil phase to form droplets (FIG. 4A). At a high pH of the dispersed phase, i.e. slow ketone-hydrazide crosslinking rate, separate pOPMA microgels are produced (FIG. 4B). Interestingly, by lowering the pH of the dispersed phase and therefore accelerating the crosslinking reaction, pOPMA microgels covalently self-assemble inside the microfluidic outlet to form fibers (FIGS. 4A and 4C). SEM analysis shows that the fibers are composed of interconnected microgels (FIG. 4D). The formed fibers in the microfluidic outlet are printed into macroscopic planar and mechanically stable free-standing 3D porous scaffolds composed of multiple layers of fibers (FIG. 4E to G). The pOPMA porous scaffolds are highly potential materials for tissue engineering. Although pOPMA does not interact with cells, it can be easily modified with functional groups to promote cell attachment and growth. We incubate pOPMA porous scaffolds within a 2-(aminooxy) ethanamine solution. The aminooxy group of 2-(aminooxy) ethanamine efficient reacts with pOPMA (native or crosslinked) to introduce cationic —NH₃⁺ groups to the scaffolds (FIGS. 22 to 23). Afterwards, fibroblast cells incubated with the scaffolds adhere to and spread on the surface and in the pores of the scaffolds (FIG. 4H).

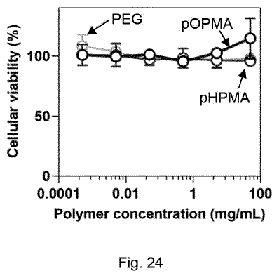

In summary, we disclose a controlled self-assembly of a simple ketone homopolymer driven by covalent crosslinking, which is employed as a new strategy to fabricate nano- to macroscale hydrogels. We demonstrate the robust and highly controlled formation of the homopolymer-based nanogels, which further assemble into macro-scale hydrogels with higher degrees of crosslinking. The crosslinking rate controls the size of the nanogels and microscale self-assembly behavior of the granular gels. The controlled covalent self-assembly is realized with a unique ketone homopolymer, pOPMA. It is based on the simplest methacrylamide monomer containing a ketone group and is structurally similar to one of the most widely used biomedical polymers, poly(N-(2-hydroxypropyl) methacrylamide), whose hydroxyl group is replaced by ketone. Although there is only one group difference between the two polymers, the ketone group in pOPMA introduces several key properties for the novel covalent self-assembly approach and related biomedical applications. These properties include its selective and potent reactivity, biocompatibility and hydrophilicity. Ketone is polar and facilitates water solubilization of the polymer. pOPMA is, to the best of our knowledge, the only ketone homopolymer with high water solubility (>300 mg/mL in PBS 7.4). Ketone is highly biocompatible and chemically more stable than another carbonyl group, aldehyde. The latter causes high toxicities including protein denaturation and DNA damage. Ketone is highly reactive towards amines with increased nucleophilicity (i.e., the α-effect), including hydrazide, hydrazine and aminooxy. These groups undergo click reactions with ketone in an efficient and clean manner, which proceeds in aqueous solvents and is catalyzed by H⁺, with water as the only side product. These reactions are considered bioorthogonal and can be applied in living systems. As shown in our study, pOPMA and POPMA-based materials are highly cytocompatible (FIG. 24).

The covalent self-assembly of POPMA enables a novel strategy of nanogel formulation. Nanogels are an important class of drug delivery systems for small molecule and macromolecular drugs. Current fabrication strategies of nanogels mostly employ inverse miniemulsion, microfluidics, and inverse nanoprecipitation. These methods involve organic solvents and/or surfactants. These components may cause denaturation of fragile payloads such as proteins and they have to be removed after formulation. Our covalent self-assembly generates nanogels without adding organic solvents and surfactants, which is a great advantage for loading pharmaceutical agents. Moreover, the new formulation process is environmentally friendly and controllable, which are important considerations for potential upscaling and translation of nanogel formulations. Furthermore, the covalent polymer self-assembly provides a practical strategy to directly synthesize polymeric nanogels below 10 nm. This is generally challenging and a previously developed method is based on intramolecular crosslinking of single polymer chains in diluted solutions. Sub-10 nm pOPMA nanogels are easily synthesized with our method by reducing the crosslinking reaction rate.

The covalent self-assembly of POPMA also provides a facile and direct method for 3D printing of porous scaffolds composed of granular hydrogels. Biomaterial scaffolds hold crucial importance in tissue engineering. Recently, porous scaffolds based on microgels have shown great advantages than conventional scaffolds, which can highly promote cell migration in the scaffolds and nutrition exchange via the large porosity. The state-of-the-art fabrication methods for such porous scaffolds begin with the production of microgels which are injected to the site of action or 3D printed, and additional crosslinking chemistry is applied to stabilize the scaffolds. Such two-step process not only adds to the fabrication complexity of microgel scaffolds, and also some crosslinking chemistry (e.g. UV) may be harmful to living cells or inapplicable in vivo. These issues are well addressed with the covalent polymer self-assembly. In our approach, microgel-based fibers are directly fabricated from microfluidics and are flexibly printed into various 3D structures. And such advanced materials engineering is simply enabled by lowering the fabrication pH to trigger microgel assembly in the outlet of the microfluidic system. The covalently self-assembled microgels result in highly stable scaffolds with chemical crosslinks between the particles. In addition, the scaffolds can be easily modified with different functional molecules to create interactions with cells, which is crucial for tissue engineering and which is not easily achievable with other polymers.

1. A method of producing a morphology-defined polymer aggregate by directly and covalently crosslinking polymer entities, the method comprising:
(a) providing polymer entities bearing covalently crosslinkable groups and respective crosslinker entities;
(b) bringing the polymer entities and the crosslinker entities in contact with each other in a solution under conditions that allow the polymer entities to aggregate or assemble into an ordered structure and be intermolecularly crosslinked in one step; and,
(c) optionally, recovering the at least one polymer aggregate.

2. The method of claim 1, wherein the crosslinkable groups are selected from the group consisting of carbonyl groups, hydroxyls, amines, hydrazines, hydrazides, hydroxylamines, disulfides, maleimides, azides, alkynes, strained alkenes, tetrazines and tetrazoles.

3. The method of claim 1, wherein at least 50% of the repeating units are crosslinkable.

4. The method of claim 1, wherein the polymer entities comprise poly(acrylates), poly(methacrylates), poly(acrylamides), poly(methacrylamides), poly(vinylethers) and derivatives thereof.

5. The method of claim 1, wherein the crosslinker entities have two or more crosslinking groups.

6. The method of claim 1, wherein the crosslinks are cleavable or degradable.

7. The method of claim 1, wherein the crosslinker entities are selected from the group consisting of ketones, aldehydes, carboxylic acids and their derivatives, hydroxyls, amines, hydrazines, hydrazides, hydroxylamines, disul-fides, maleimides, azides, alkynes, strained alkenes, tetrazines and tetrazoles.

8. The method of claim 1, wherein 5 to 100% of the repeating units of the polymer aggregate are crosslinked.

9. The method of claim 1, wherein the produced polymer aggregate is selected from the group consisting of nanoparticles, microstructures and macrostructures.

10. A polymer aggregate, produced according to the method of claim 1.

11. The method of claim 2, wherein the carbonyl groups are selected from ketones, aldehydes, carboxylic acids and their derivatives.

12. The method of claim 4, wherein the polymer entities comprise ketone-bearing poly(methacrylamides) or poly(acrylamides).

13. The method of claim 4, wherein the polymer entities comprise poly(N-(2-oxopropyl) methacrylamide) (pOPMA).

14. The method of claim 9, wherein the microstructures and macro-structures are composed of nanoparticles.

15. The method of claim 5, wherein the two or more crosslinking groups are spaced apart from each other by linkages of 1 to 1000 atoms in length.

16. The method of claim 5, wherein the two or more crosslinking groups are spaced apart from each other by linkages of 2 to 10 atoms in length.

17. The method of claim 4, wherein the polymer entities consist of poly(acrylates), poly(methacrylates), poly(acrylamides), poly(methacrylamides), poly(vinylethers) and derivatives thereof.

18. The method of claim 4, wherein the polymer entities consist of ketone-bearing poly(methacrylamides) or poly(acrylamides).

19. The method of claim 4, wherein the polymer entities consist of poly(N-(2-oxopropyl) methacrylamide) (pOPMA).
